(19) United States
(12) Patent Application Publication
(10) Pub. No.: US 2025/0335864 A1
(43) Pub. Date: Oct. 30, 2025

(54) SYSTEMS AND METHODS FOR ELECTRONIC CATALOG MANAGEMENT

(71) Applicant: ServiceTitan, Inc., Glendale, CA (US)

(72) Inventors: Wing Lam, San Gabriel, CA (US); Tianyu Qiu, Glendale, CA (US); Juliette Armour-Wilson, Santa Barbara, CA (US); Eyal Binshtock, Glendale, CA (US); Ruslan Shokhirev, Glendale, CA (US)

(21) Appl. No.: 19/195,063

(22) Filed: Apr. 30, 2025

Related U.S. Application Data
(60) Provisional application No. 63/640,461, filed on Apr. 30, 2024.

(51) Int. Cl. G06Q 10/087; G06Q 30/04

(52) U.S. Cl. CPC G06Q 10/087; G06Q 30/04

(57) ABSTRACT

Methods and systems for electronic catalog management are disclosed. A primary embedding is generated using a machine learning model. The primary embedding is associated with a generic line item corresponding to a service job to be performed by a tenant. A plurality of secondary embeddings is generated using the machine learning model. Each of the plurality of secondary embeddings is associated with a tenant-specific line item from a plurality of tenant-specific line items. Based on comparing the primary embedding to each of the plurality of secondary embeddings, a subset of the tenant-specific line items that corresponds to the generic line item is determined. In response to receiving, at a user device associated with the tenant, input data indicating that the service job is to be performed by the tenant for a customer, display of the subset of the tenant-specific line items that corresponds to the generic line item is caused.

### CROSS-REFERENCE TO RELATED APPLICATIONS

This application is a nonprovisional of U.S. Provisional Application No. 63/640,461 filed Apr. 30, 2024, which is incorporated by reference as if fully set forth herein.

### BACKGROUND

A tenant may hire service technicians (e.g., heating, ventilation, and air conditioning (HVAC) technicians, electricians, plumbers, etc.) to perform service jobs for customers. Service technicians may generate invoices for performed service jobs. It is important for such invoices to accurately reflect the services and/or materials provided to the customers so that the tenant can track its inventory.

### SUMMARY

Methods, systems, and devices for electronic catalog management are disclosed. The disclosed embodiments provide for a method for electronic catalog management. A primary embedding is generated using a machine learning model, such as a large language model. The primary embedding is associated with a generic line item (e.g., stock keeping unit (SKU)), such as a generic material, corresponding to a service job to be performed by a tenant. A plurality of secondary embeddings is generated using the machine learning model. Each of the plurality of secondary embeddings is associated with a particular tenant-specific line item (e.g., SKU), such as a tenant-specific material, from a plurality of tenant-specific line items. A subset of the tenant-specific line items that corresponds to the generic line item is determined. The subset of the tenant-specific line items is determined based on comparing the primary embedding to each of the plurality of secondary embeddings. Input data indicating that the service job is to be performed by the tenant for a customer is received at a user device. In response to the input data being received at the user device, display of the subset of the tenant-specific materials is caused via an interface of the user device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate embodiments and together with the description, serve to explain the principles of the methods and systems.

FIG. 1 is an example system.

FIG. 2 is an example method.

FIG. 3 is an example method.

FIG. 4 is an example method.

FIG. 5 is an example method.

FIG. 6 is an example computing device.

An appendix is also attached with which one or more implementations of the subject technology may be implemented.

### DETAILED DESCRIPTION OF ILLUSTRATIVE EMBODIMENTS

Methods and systems for electronic (e.g., digital) catalog management are disclosed. A electronic catalog management service may provide a electronic catalog (e.g., price book) of generic (e.g., general, nonspecific) services (e.g., repair toilet) and/or generic materials (e.g., toilet, water heater, etc.) to various tenants (e.g., home service companies). Each of the tenants may be a service provider, business, and/or company that performs service jobs (e.g., heating, ventilation, and air conditioning (HVAC) repair and maintenance, electrical or mechanical repair and maintenance, plumbing, etc.) for customers. The tenants may receive requests from customers. The requests can include requests for the tenants to perform service jobs for the customers, such as at a location (e.g., home, business, etc.) associated with the customer. In response to receiving a request from a customer, a tenant may dispatch one or more service technicians to the customer location (e.g., job site) to perform the service job.

At each job site, the service technicians may need to generate an estimate and/or invoice for the service job. The service technicians may utilize the generic electronic catalog (e.g., price book) provided by the electronic catalog management service to generate these estimates and/or invoices. However, each of the various tenants may provide slightly different services (e.g., different toilet repair services) and/or may utilize different materials (e.g., different brands of materials, different sizes of materials, etc.). Estimates and/or invoices generated using only the generic electronic catalog (e.g., price book) provided by the electronic catalog management service may not account for these tenant-specific services and/or tenant-specific materials. The tenants may therefore be unable to accurately track their provided services and/or inventory. As such, improved techniques for electronic catalog management are needed.

Described herein are improved techniques for electronic catalog management. The techniques described herein enable tenants to automatically link or map their tenant-specific services and/or tenant-specific materials (collectively referred to as “tenant-specific line-items”) to the generic services and/or generic materials (collectively referred to as “generic line-items”) listed in the electronic catalog. For example, a generic material listed in the electronic catalog may be a “water heater.” One of the specific water heaters that a tenant offers to its customers may be a “40 gallon American Standard electric water heater.” The techniques described here automatically link the tenant's “40 gallon American Standard electric water heater” (along with any other water heater that the tenant offers to its customers) to the generic “water heater” listed in the electronic catalog. Because the tenant-specific line items are linked (e.g., mapped) to the generic line items, when the service technicians utilize the generic electronic catalog (e.g., price book) provided by the electronic catalog management service to generate estimates and/or invoices, such estimates and/or invoices may accurately reflect the actual services and materials provided by a tenant to its customers, thereby enabling tenants to accurately track their provided services and/or inventory.

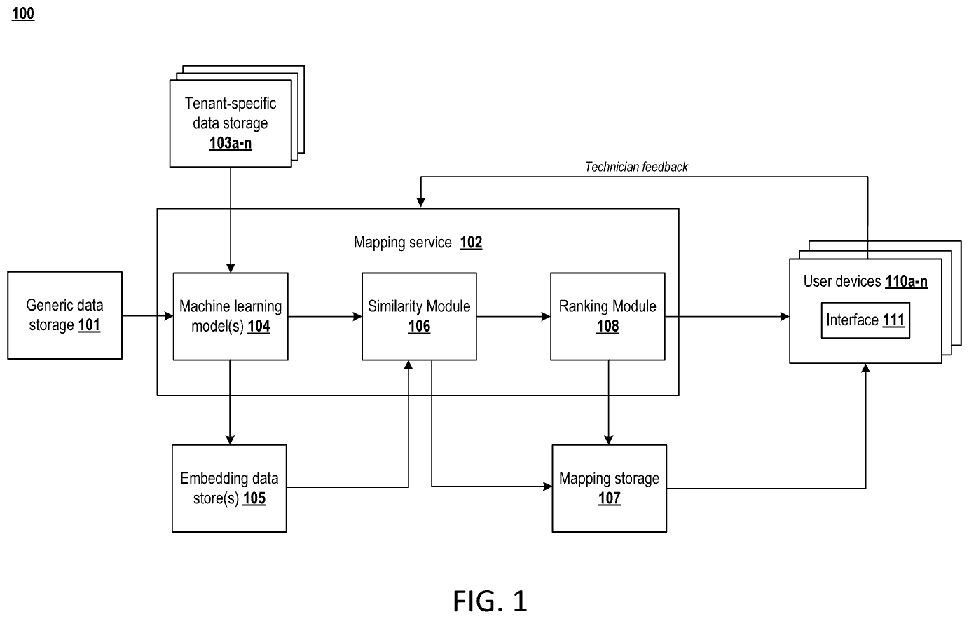

FIG. 1 shows a block diagram of an example system 100. The system 100 may include a generic data storage 101, one or more tenant-specific data storages 103a-n, an embedding data storage 105, a mapping service 102, a mapping storage 107, and one or more user devices 110a-n. The system 100 may be used to implement the techniques described herein. In particular, the system 100 may be used to automatically link or map tenant-specific line-items to generic line-items, thereby enabling tenants to accurately track their provided services and/or inventory.

The generic data storage 101 may store a electronic catalog (e.g., price book) of generic (e.g., general, nonspecific) line items (e.g., SKUs). The generic line items may include generic services and/or generic materials. Generic line items may each correspond to a broad category of services or materials so that various different tenants can use the electronic catalog, regardless of the specific services or materials that they offer to their customers. However generic line items do not represent the specific services or materials that the tenants offer to their customers. Instead, data indicating the specific services or materials that the tenants offer to their customers may be stored in the tenant-specific data storages 103a-n. For example, data indicating tenant-specific line items (e.g., SKUs) may be stored in the tenant-specific data storages 103a-n. Each of the tenant-specific data storages 103a-n may correspond to a particular tenant. For example, the tenant specific data storages 103a may store data indicating tenant-specific line items corresponding to a first tenant, the tenant specific data storages 103b may store data indicating tenant-specific line items corresponding to a second tenant, and so on.

The mapping service 102 may be configured to map (e.g., link) the generic line items in the generic data storage 101 to the tenant-specific line items (e.g., SKUs) stored in each of the tenant-specific data storages 103a-n. The mapping service 102 may include one or more machine learning models 104. The machine learning model(s) 104 may be trained with a training dataset that includes a large corpus of data. The machine learning model(s) 104 may, for example, include a large language model (LLM). The machine learning model(s) 104 may be configured to generate a primary embedding associated with each of the generic line items in the generic data storage 101. For example, the machine learning model(s) 104 may be configured to convert text associated with each of the generic line items into a same-length numeric vector (e.g., embedding). The machine learning model(s) 104 may further be configured to generate a secondary embedding associated with each of the tenant-specific line items in each of the tenant-specific data storages 103a-n. For example, the machine learning model(s) 104 may be configured to convert text associated with each of the tenant-specific line items into a same-length numeric vector (e.g., embedding).

To avoid repeated calculation of embeddings, the machine learning model(s) 104 may cause storage of the primary embeddings and secondary embeddings in the embedding data storage 105. The embeddings in the embedding data storage 105 may not be updated until the generic line items in the generic data storage 101 and/or the tenant-specific line items (e.g., SKUs) stored in one or more of the tenant-specific data storages 103a-n are modified. For example, if a new tenant-specific line item (e.g., SKU) is added to the tenant-specific data storages 103a-n, a new secondary embedding corresponding to the new tenant-specific line item may be generated and added to the embedding data storage 105 to keep the embedding data storage 105 in sync with the generic data storage 101 and the tenant-specific data storages 103a-n. Likewise, if a tenant-specific line item (e.g., SKU) is deleted from the tenant-specific data storages 103a-n, the secondary embedding corresponding to that tenant-specific line item may be deleted from the embedding data storage 105 to keep the embedding data storage 105 in sync with the generic data storage 101 and the tenant-specific data storages 103a-n.

A similarity module 106 of the mapping service 102 may be configured to determine, for each tenant, which generic line item each of the tenant-specific line items corresponds to. For a given generic line item, the similarity module 106 may be configured to determine, for each tenant, a subset of the tenant-specific line items that corresponds to that generic line item. For example, given a generic material “water heater,” the similarity module 106 may be configured to determine, for each tenant, a subset of the tenant-specific materials that are water heaters. The tenant-specific water heaters may be specific brands and/or sizes of water heaters that the tenant offers to its customers. The subset of the tenant-specific line items that corresponds to that generic line item may include any quantity of line items, such as one, two, three, four, five, six, seven, eight, nine, ten, etc. line items.

Determining which generic line item each of the tenant-specific line items corresponds to may include comparing the primary embedding associated with a particular generic line item to each of the secondary embeddings for a particular tenant. The primary embedding associated with a particular generic line item may be compared to each of the secondary embeddings for a particular tenant to determine a similarity (e.g., cosine similarity) between the primary embedding and each of the secondary embeddings. The subset of the tenant-specific line items that corresponds to that generic line item may be those tenant-specific line items corresponding to the secondary embeddings having a similarity (e.g., cosine similarity) to the primary embedding that satisfies a predetermined threshold. The predetermined threshold may have been determined by maximizing the accuracy of the machine learning model(s) 104 over a ground truth dataset. The similarity module 106 may cause storage of data indicating the subset of the tenant-specific line items that corresponds to each generic line item in the mapping storage 107.

In embodiments, a ranking module 108 of the mapping service 102 may be configured to rank the subset of the tenant-specific line items that corresponds to each generic line item. The ranking module 108 may rank the subset of the tenant-specific line items based at least on the similarity (e.g., cosine similarity) between the primary embedding and the secondary embeddings corresponding to each of the subset of the tenant-specific line items. For example, the tenant-specific line item of the subset having a secondary embedding that is most similar to the primary embedding may be ranked first, the tenant-specific line item of the subset having a secondary embedding that is the next most similar to the primary embedding may be ranked second, and so on. The ranking module 108 may cause storage of data indicating a ranked order of the subset of the tenant-specific line items that corresponds to each generic line item in the mapping storage 107.

In embodiments, the ranking module 108 may additionally, or alternatively, rank the subset of the tenant-specific line items based on a popularity associated with each of the subset of the tenant-specific items. The popularity associated with a particular tenant-specific material may indicate how frequently that line item has been used to generate an estimate and/or invoice in the past. For example, the popularity associated with a particular tenant-specific material may indicate how frequently a service technician has previously selected that line item when generating an invoice and/or estimate. The more popular a line item (e.g., the more frequently the line item has been used to generate an estimate and/or invoice), the higher the line item may be ranked by the ranking module 108.

A tenant may dispatch a service technician to a job site to perform a service job (e.g., a heating, ventilation, and/or air conditioning (HVAC) repair or maintenance, electrical or mechanical repair or maintenance, plumbing, etc.) for a customer. The service technician may arrive at the job site to perform the service job. The service technician may bring a portable electronic device, such as one of the user devices 210a-n, to the job site. The portable electronic device may include, for example, a laptop, a tablet, a mobile phone, etc. The service technician may utilize the portable electronic device to generate an estimate and/or invoice for the service job. To generate the estimate and/or invoice for the service job, the service technician may select, via an interface 111 of the portable electronic device, a generic service that the service technician is to perform at the job site. For example, the service technician may select “install water heater” from a list of generic services that are displayed via the interface 111.

In embodiments, in response to the generic service selection, a list of the subset of tenant-specific line items (e.g., tenant-specific services and/or tenant-specific materials) corresponding to the generic service may be displayed via the interface 111. For example, a list of the subset of tenant-specific line items corresponding to the generic service may be displayed in rank order via the interface 111. To display the list of the subset of tenant-specific line items corresponding to the generic service, the portable electronic device may request data indicating the subset of tenant-specific line items corresponding to the generic service from the mapping storage 107. The portable electronic device may request data indicating the subset of tenant-specific line items corresponding to the generic service from the mapping storage 107 in response to the generic service selection.

Alternatively, the portable electronic device may request data indicating the subset of tenant-specific line items corresponding to the generic service from the mapping service 102, and the mapping service 102 may generate the data indicating the subset of tenant-specific line items corresponding to the generic service in real-time. The portable electronic device may request data indicating the subset of tenant-specific line items corresponding to the generic service from the mapping service 102 in response to the generic service selection. The service technician may select, via the interface 111, one or more of the tenant-specific line items from the displayed list. Based on the selected tenant-specific line item(s), the portable electronic device may generate an estimate and/or invoice for the service job.

In embodiments, in response to the generic service selection, one or more generic materials may be displayed. The generic material(s) may correspond to the generic service. For example, if the service technician selects “install water heater” from the list of generic services, the generic material “water heater” may be displayed via the interface 111. The service technician may select the generic material “water heater.” In response to the generic material selection, a list of a subset of tenant-specific materials corresponding to the generic material may be displayed via the interface 111. For example, a list of a subset of tenant-specific materials corresponding to the generic material may be displayed in rank order via the interface 111.

To display the list of the subset of tenant-specific materials corresponding to the generic material, the portable electronic device may request data indicating the subset of tenant-specific materials corresponding to the generic material from the mapping storage 107. The portable electronic device may request data indicating the subset of tenant-specific materials corresponding to the generic material from the mapping storage 107 in response to the generic material selection. Alternatively, the portable electronic device may request data indicating the subset of tenant-specific materials corresponding to the generic material from the mapping service 102, and the mapping service 102 may generate the data indicating the subset of tenant-specific materials corresponding to the generic material in real-time. The portable electronic device may request data indicating the subset of tenant-specific materials corresponding to the generic material from the mapping service 102 in response to the generic material selection. The service technician may select, via the interface 111, one or more of the tenant-specific materials from the displayed list. Based on the selected tenant-specific material(s), the portable electronic device may generate an estimate and/or invoice for the service job.

In embodiments, service technician feedback (e.g., data indicating the technician-selected tenant-specific line item) may be used to continually update the machine learning model(s) 104 and/or the ranking module 108. For example, data indicating the technician-selected tenant-specific line item may be used to update or modify the parameters of the machine learning model(s) 104. It may be determined whether accuracy of the machine learning model(s) 104 improves with the updated parameters. If the accuracy improves with the updated parameters, the original machine learning model(s) 104 may be replaced with the fine-tuned model. Further, data indicating the technician-selected tenant-specific line item may be used to update or modify the ranking module 108. For example, if the feedback data indicates that the technician selected a tenant-specific water heater, the ranking module 108 may assign that particular tenant-specific water heater a higher ranking in the future.

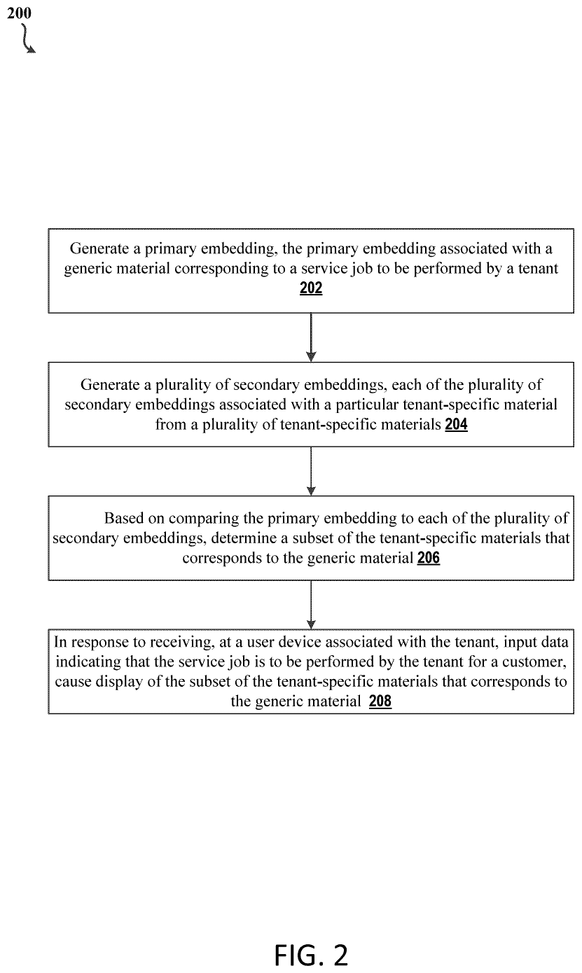

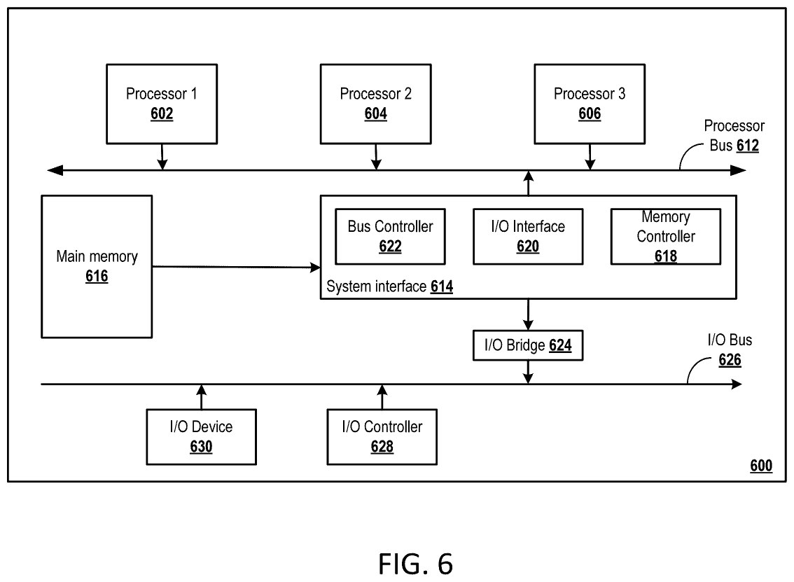

FIG. 2 is an example method 200. The method 200 may include a computer implemented method for electronic catalog management. A system and/or computing environment, such as the system 100 of FIG. 1 and/or the computing environment of FIG. 6 may be configured to perform the method 200.

A electronic catalog (e.g., price book) may include various generic (e.g., general, nonspecific) line items (e.g., SKUs). The generic line items may include generic services and/or generic materials offered to customers by various tenants. Each of the generic line items may correspond to a broad category of services or materials so that the different tenants can use the electronic catalog, regardless of the specific services or materials that they offer to their customers. However, the generic line items do not represent the specific services or materials that each of the tenants offer to their customers. Instead, data indicating the specific services or materials that a particular tenant offers to its customers may be stored in a tenant-specific data storage. For example, data indicating tenant-specific line items (e.g., SKUs) may be stored in the tenant-specific data storage.

The generic line items may be mapped (e.g., linked) to the tenant-specific line items (e.g., SKUs) stored in the tenant-specific data storage. At 202, a primary embedding may be generated. The primary embedding may be associated with a generic line item corresponding to a service job to be performed by a tenant. The primary embedding may be generated using one or machine learning models. The machine learning model(s) may, for example, include a large language model (LLM). At 204, secondary embeddings may be generated. Each of the secondary embeddings may be associated with a particular tenant-specific line item (e.g., from the tenant-specific line items stored in the tenant-specific data storage). The secondary embeddings may be generated by the machine learning model(s).

It may be determined which generic line item each of the tenant-specific line items corresponds to. At 206, a subset of the tenant-specific line items may be determined. The subset of the tenant-specific line items may include one or more tenant-specific line items that correspond to the generic line item. The subset of the tenant-specific line items may be determined based on comparing the primary embedding to each of the secondary embeddings. For example, the primary embedding may be compared to each of the secondary embeddings to determine a similarity (e.g., cosine similarity) between the primary embedding and each of the secondary embeddings. The subset of the tenant-specific line items that corresponds to that generic line item may be those tenant-specific line items corresponding to the secondary embeddings having a similarity (e.g., cosine similarity) to the primary embedding that satisfies a predetermined threshold.

The tenant may dispatch a service technician to a job site to perform a service job (e.g., a heating, ventilation, and/or air conditioning (HVAC) repair or maintenance, electrical or mechanical repair or maintenance, plumbing, etc.) for a customer. The service technician may arrive at the job site to perform the service job. The service technician may bring a user device (e.g., portable electronic device) to the job site. The portable electronic device may include, for example, a laptop, a tablet, a mobile phone, etc. The service technician may utilize the portable electronic device to generate an estimate and/or invoice for the service job. To generate the estimate and/or invoice for the service job, the service technician may select, via an interface of the portable electronic device, a generic service that the service technician is to perform at the job site. For example, the service technician may select “install water heater” from a list of generic services that are displayed via the interface.

At 208, display of the subset of the tenant-specific line items that corresponds to the generic service may be displayed. In embodiments, in response to the generic service selection (e.g., input data indicating that the service job is to be performed by the tenant for a customer), a list of the subset of tenant-specific line items (e.g., tenant-specific services and/or tenant-specific materials) corresponding to the generic service may automatically be displayed via the interface of the user device. In other embodiments, in response to the generic service selection, one or more generic materials may be displayed. The generic material(s) may correspond to the generic service. For example, if the service technician may select “install water heater” from the list of generic services, the generic material “water heater” may be displayed via the interface. The service technician may select the generic material “water heater.” In response to the generic material selection, a list of a subset of tenant-specific materials corresponding to the generic material may be displayed via the interface. The service technician may select, via the interface, one or more of the tenant-specific line items from the subset. An estimate and/or invoice for the service job may be generated based on the selected tenant-specific line item(s).

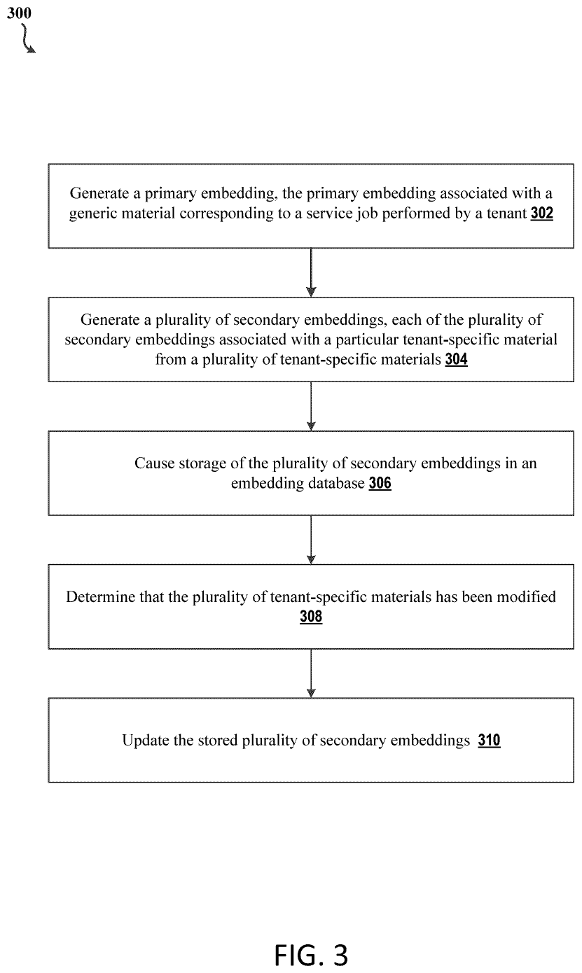

FIG. 3 is an example method 300. The method 300 may include a computer implemented method for electronic catalog management. A system and/or computing environment, such as the system 100 of FIG. 1 and/or the computing environment of FIG. 6 may be configured to perform the method 300.

A electronic catalog (e.g., price book) may include various generic (e.g., general, nonspecific) line items (e.g., SKUs). The generic line items may include generic services and/or generic materials offered to customers by various tenants. Each of the generic line items may correspond to a broad category of services or materials so that the different tenants can use the electronic catalog, regardless of the specific services or materials that they offer to their customers. However, the generic line items do not represent the specific services or materials that each of the tenants offer to their customers. Instead, data indicating the specific services or materials that a particular tenant offers to its customers may be stored in a tenant-specific data storage. For example, data indicating tenant-specific line items (e.g., SKUs) may be stored in the tenant-specific data storage.

The generic line items may be mapped (e.g., linked) to the tenant-specific line items (e.g., SKUs) stored in the tenant-specific data storage. At 302, a primary embedding may be generated. The primary embedding may be associated with a generic line item corresponding to a service job to be performed by a tenant. The primary embedding may be generated using one or machine learning models. The machine learning model(s) may, for example, include a large language model (LLM). At 304, secondary embeddings may be generated. Each of the secondary embeddings may be associated with a particular tenant-specific line item (e.g., from the tenant-specific line items stored in the tenant-specific data storage). The secondary embeddings may be generated by the machine learning model(s).

To avoid repeated calculation of embeddings, the primary embeddings and/or the secondary embeddings may be stored in an embedding database. At 306, storage of the secondary embeddings may be caused. For example, the secondary embeddings may be stored in an embedding database. The primary embedding may similarly be stored in the database or in a different database. The embeddings in the embedding database may not be updated until the generic line items in the electronic catalog and/or the tenant-specific line items (e.g., SKUs) stored in the tenant-specific data storage are modified. At 308, it may be determined that the tenant-specific materials have been modified. For example, it may be determined that a new tenant-specific line item (e.g., SKU) has been added to the tenant-specific data storage, a tenant-specific line item has been deleted from the tenant-specific data storage, and/or that a description of a tenant-specific line item in the tenant-specific data storage has been changed. At 310, the stored secondary embeddings may be updated. The stored secondary embeddings may be updated based on (e.g., in response to) the determination that the tenant-specific materials have been modified. The stored secondary embeddings may be updated to keep the embedding database in sync with the tenant-specific data storage.

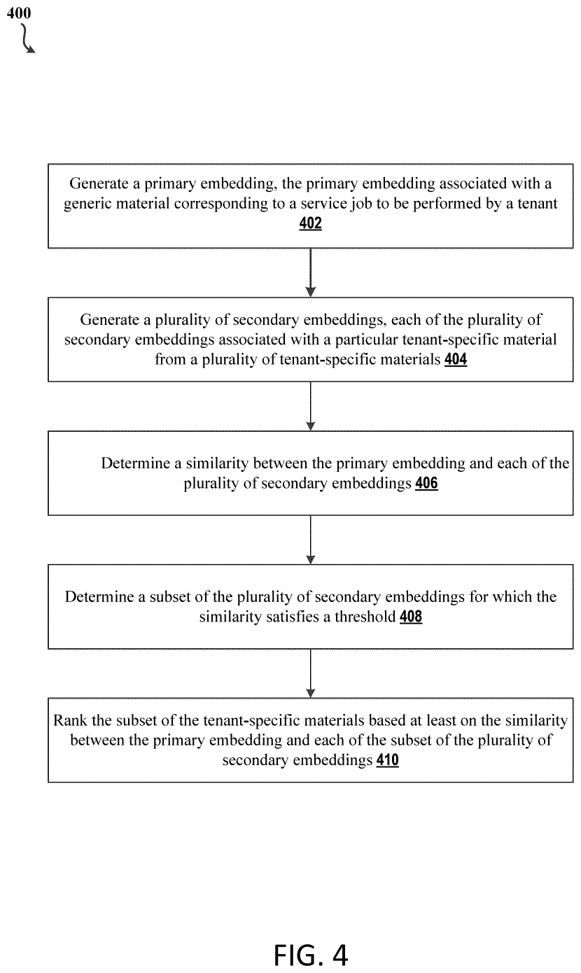

FIG. 4 is an example method 400. The method 400 may include a computer implemented method for electronic catalog management. A system and/or computing environment, such as the system 100 of FIG. 1 and/or the computing environment of FIG. 6 may be configured to perform the method 400.

A electronic catalog (e.g., price book) may include various generic (e.g., general, nonspecific) line items (e.g., SKUs). The generic line items may include generic services and/or generic materials offered to customers by various tenants. Each of the generic line items may correspond to a broad category of services or materials so that the different tenants can use the electronic catalog, regardless of the specific services or materials that they offer to their customers. However, the generic line items do not represent the specific services or materials that each of the tenants offer to their customers. Instead, data indicating the specific services or materials that a particular tenant offers to its customers may be stored in a tenant-specific data storage. For example, data indicating tenant-specific line items (e.g., SKUs) may be stored in the tenant-specific data storage.

The generic line items may be mapped (e.g., linked) to the tenant-specific line items (e.g., SKUs) stored in the tenant-specific data storage. At 402, a primary embedding may be generated. The primary embedding may be associated with a generic line item corresponding to a service job to be performed by a tenant. The primary embedding may be generated using one or machine learning models. The machine learning model(s) may, for example, include a large language model (LLM). At 404, secondary embeddings may be generated. Each of the secondary embeddings may be associated with a particular tenant-specific line item (e.g., from the tenant-specific line items stored in the tenant-specific data storage). The secondary embeddings may be generated by the machine learning model(s).

It may be determined which generic line item each of the tenant-specific line items corresponds to. A subset of the tenant-specific line items may be determined. The subset of the tenant-specific line items may include one or more tenant-specific line items that correspond to the generic line item. The subset of the tenant-specific line items may be determined based on comparing the primary embedding to each of the secondary embeddings. For example, the primary embedding may be compared to each of the secondary embeddings to determine a similarity (e.g., cosine similarity) between the primary embedding and each of the secondary embeddings. At 406, a similarity between the primary embedding and each of the secondary embeddings may be determined. At 408, a subset of the secondary embeddings for which the similarity satisfies a threshold may be determined. The subset of the tenant-specific line items that corresponds to that generic line item may be those tenant-specific line items corresponding to the secondary embeddings having the similarity satisfies the threshold.

The subset of the tenant-specific line items that corresponds to that generic line item may be ranked. The subset of the tenant-specific line items that corresponds to that generic line item may be ranked based at least on the similarity (e.g., cosine similarity) between the primary embedding and the secondary embeddings corresponding to each of the subset of the tenant-specific line items. For example, the tenant-specific line item of the subset having a secondary embedding that is most similar to the primary embedding may be ranked first, the tenant-specific line item of the subset having a secondary embedding that is the next most similar to the primary embedding may be ranked second, and so on. Additionally, or alternatively, the subset of the tenant-specific line items that corresponds to that generic line item may be ranked based on a popularity associated with each of the subset of the tenant-specific items. The popularity associated with a particular tenant-specific material may indicate how frequently that line item has been used to generate an estimate and/or invoice in the past. For example, the popularity associated with a particular tenant-specific material may indicate how frequently a service technician has previously selected that line item when generating an invoice and/or estimate. The more popular a line item (e.g., the more frequently the line item has been used to generate an estimate and/or invoice), the higher the line item may be ranked. Display of the subset of the tenant-specific line items that corresponds to the generic service may be displayed, such as in rank order, via an interface of a user device.

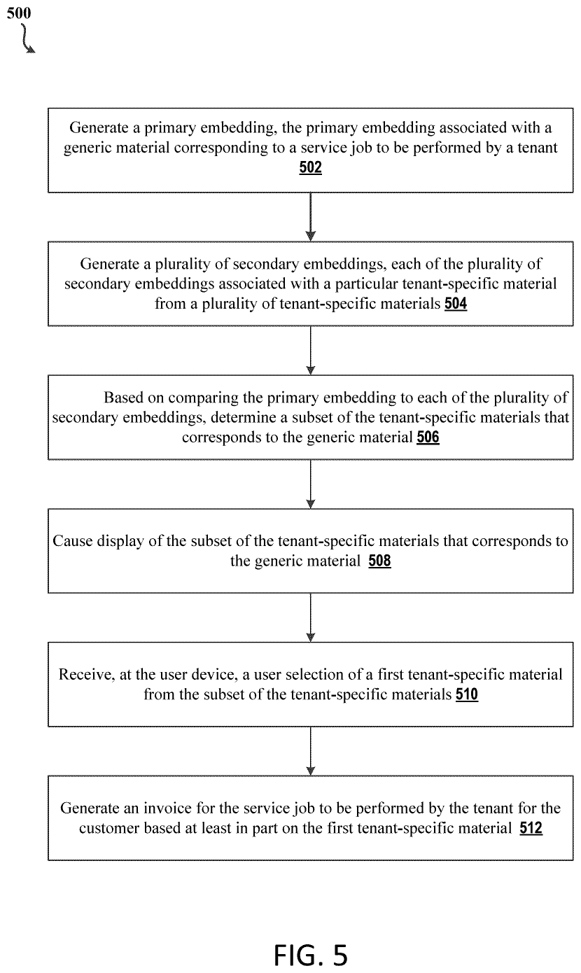

FIG. 5 is an example method 500. The method 500 may include a computer implemented method for electronic catalog management. A system and/or computing environment, such as the system 100 of FIG. 1 and/or the computing environment of FIG. 6 may be configured to perform the method 500.

A electronic catalog (e.g., price book) may include various generic (e.g., general, nonspecific) line items (e.g., SKUs). The generic line items may include generic services and/or generic materials offered to customers by various tenants. Each of the generic line items may correspond to a broad category of services or materials so that the different tenants can use the electronic catalog, regardless of the specific services or materials that they offer to their customers. However, the generic line items do not represent the specific services or materials that each of the tenants offer to their customers. Instead, data indicating the specific services or materials that a particular tenant offers to its customers may be stored in a tenant-specific data storage. For example, data indicating tenant-specific line items (e.g., SKUs) may be stored in the tenant-specific data storage.

The generic line items may be mapped (e.g., linked) to the tenant-specific line items (e.g., SKUs) stored in the tenant-specific data storage. At 502, a primary embedding may be generated. The primary embedding may be associated with a generic line item corresponding to a service job to be performed by a tenant. The primary embedding may be generated using one or machine learning models. The machine learning model(s) may, for example, include a large language model (LLM). At 504, secondary embeddings may be generated. Each of the secondary embeddings may be associated with a particular tenant-specific line item (e.g., from the tenant-specific line items stored in the tenant-specific data storage). The secondary embeddings may be generated by the machine learning model(s).

It may be determined which generic line item each of the tenant-specific line items corresponds to. At 506, a subset of the tenant-specific line items may be determined. The subset of the tenant-specific line items may include one or more tenant-specific line items that correspond to the generic line item. The subset of the tenant-specific line items may be determined based on comparing the primary embedding to each of the secondary embeddings. For example, the primary embedding may be compared to each of the secondary embeddings to determine a similarity (e.g., cosine similarity) between the primary embedding and each of the secondary embeddings. The subset of the tenant-specific line items that corresponds to that generic line item may be those tenant-specific line items corresponding to the secondary embeddings having a similarity (e.g., cosine similarity) to the primary embedding that satisfies a predetermined threshold.

The tenant may dispatch a service technician to a job site to perform a service job (e.g., a heating, ventilation, and/or air conditioning (HVAC) repair or maintenance, electrical or mechanical repair or maintenance, plumbing, etc.) for a customer. The service technician may arrive at the job site to perform the service job. The service technician may bring a user device (e.g., portable electronic device) to the job site. The portable electronic device may include, for example, a laptop, a tablet, a mobile phone, etc. The service technician may utilize the portable electronic device to generate an estimate and/or invoice for the service job. To generate the estimate and/or invoice for the service job, the service technician may select, via an interface of the portable electronic device, a generic service that the service technician is to perform at the job site. For example, the service technician may select “install water heater” from a list of generic services that are displayed via the interface.

At 508, display of the subset of the tenant-specific line items that corresponds to the generic service may be displayed. In embodiments, in response to the generic service selection (e.g., input data indicating that the service job is to be performed by the tenant for a customer), a list of the subset of tenant-specific line items (e.g., tenant-specific services and/or tenant-specific materials) corresponding to the generic service may automatically be displayed via the interface of the user device. In other embodiments, in response to the generic service selection, one or more generic materials may be displayed. The generic material(s) may correspond to the generic service. For example, if the service technician may select “install water heater” from the list of generic services, the generic material “water heater” may be displayed via the interface. The service technician may select the generic material “water heater.” In response to the generic material selection, a list of a subset of tenant-specific materials corresponding to the generic material may be displayed via the interface.

The service technician may select one or more tenant-specific line items from the displayed list of the subset of the tenant-specific line items. At 510, user selection may be received. The user selection may be received at the user device, such as via the interface of the user device. The user selection may include a selection of a first tenant-specific line item from the subset of the tenant-specific line items. At 512, an invoice and/or estimate for the service job to be performed by the tenant for the customer may be generated. The invoice and/or estimate for the service job may be generated based at least in part on the selected first tenant-specific line item. Because the tenant-specific line items are linked (e.g., mapped) to the generic line items, the estimate and/or invoice may accurately reflect the actual services and materials provided by the tenant to its customers, thereby enabling the tenant to accurately track their provided services and/or inventory.

FIG. 6 depicts a computing device that may be used in various aspects, such as the devices and/or components depicted in FIG. 1. With regard to the example architecture of FIG. 1, any of the components may each be implemented in an instance of a computing device 600 of FIG. 6. The computer architecture shown in FIG. 6 shows a conventional server computer, workstation, desktop computer, laptop, tablet, network appliance, PDA, e-reader, electronic cellular phone, or other computing node, and may be utilized to execute any aspects of the computers described herein, such as to implement the methods described in relation to FIGS. 2-5.

The computer system (system) includes one or more processors (e.g., 602, 604, and 606). The processors 602-606 may include one or more internal levels of cache (not shown) and a bus controller 622 or bus interface unit to direct interaction with a processor bus 612. The processor bus 612, also known as the host bus or the front side bus, may be used to couple the processors 602-606 with a system interface 614. The system interface 614 may be connected to the processor bus 612 to interface other components of the computing device 600 with the processor bus 612. For example, the system interface 614 may include a memory controller 618 for interfacing a main memory 616 with the processor bus 612. The main memory 616 typically includes one or more memory cards and a control circuit (not shown). System interface 614 may also include an input/output (I/O) interface 620 to interface one or more I/O bridges (e.g., I/O bridge 624) or I/O devices with the processor bus 612. One or more I/O controllers and/or I/O devices may be connected with the I/O bus 626, such as I/O controller 628 and I/O device 630, as illustrated.

I/O device 630 may also include an input device (not shown), such as an alphanumeric input device, including alphanumeric and other keys for communicating information and/or command selections to the processors 602-606. Another type of user input device includes cursor control, such as a mouse, a trackball, or cursor direction keys for communicating direction information and command selections to the processors 602-606 and for controlling cursor movement on the display device.

The computing device 600 may include a dynamic storage device, referred to as main memory 616, or a random access memory (RAM) or other computer-readable devices coupled to the processor bus 612 for storing information and instructions to be executed by the processors 602-606. Main memory 616 also may be used for storing temporary variables or other intermediate information during execution of instructions by the processors 602-606. The computing device 600 may include a read only memory (ROM) and/or other static storage device coupled to the processor bus 612 for storing static information and instructions for the processors 602-606. The system set forth in FIG. 6 is but one possible example of a computer system that may employ or be configured in accordance with aspects of the present disclosure.

According to one embodiment, the above techniques may be performed by computing device 600 in response to processor 604 executing one or more sequences of one or more instructions contained in main memory 616. These instructions may be read into main memory 616 from another machine-readable medium, such as a storage device. Execution of the sequences of instructions contained in main memory 616 may cause processors 602-606 to perform the process steps described herein. In alternative embodiments, circuitry may be used in place of or in combination with the software instructions. Thus, embodiments of the present disclosure may include both hardware and software components.

A machine-readable medium includes any mechanism for storing or transmitting information in a form (e.g., software, processing application) readable by a machine (e.g., a computer). Such media may take the form of, but is not limited to, non-volatile media and volatile media. Non-volatile media includes optical or magnetic disks. Volatile media includes dynamic memory, such as main memory 616. Common forms of machine-readable medium may include, but is not limited to, magnetic storage medium; optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “include” and variations of the word, such as “comprising” and “includes,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, or in addition, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the subject technology may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed is:

1. A method comprising:
generating, using a machine learning model, a primary embedding, wherein the primary embedding is associated with a generic line item corresponding to a service job to be performed by a tenant;
generating, using the machine learning model, a plurality of secondary embeddings, wherein each of the plurality of secondary embeddings is associated with a particular tenant-specific line item from a plurality of tenant-specific line items;
based on comparing the primary embedding to each of the plurality of secondary embeddings, determining a subset of tenant-specific line items that corresponds to the generic line item from the plurality of tenant-specific line items; and
in response to receiving, at a user device associated with the tenant, input data indicating that the service job is to be performed by the tenant for a customer, causing display of the subset of tenant-specific line items that corresponds to the generic line item.

2. The method of claim 1, wherein generating the primary embedding comprises converting text associated with the generic line item into a primary vector, and wherein generating the plurality of secondary embeddings comprises converting text associated with each of the plurality of tenant-specific line items into a secondary vector.

3. The method of claim 1, further comprising:
causing storage of the plurality of secondary embeddings in an embedding database.

4. The method of claim 3, further comprising:
updating the stored plurality of secondary embeddings in response to determining that the plurality of tenant-specific line items has been modified.

5. The method of claim 1, wherein comparing the primary embedding to each of the plurality of secondary embeddings comprises determining a similarity between the primary embedding and each of the plurality of secondary embeddings.

6. The method of claim 5, wherein determining the subset of the tenant-specific line items that corresponds to the generic line item comprises determining a subset of the plurality of secondary embeddings for which the similarity satisfies a threshold.

7. The method of claim 6, further comprising:
ranking the subset of the tenant-specific line items based at least on the similarity between the primary embedding and each of the subset of the plurality of secondary embeddings, wherein causing display of the subset of the tenant-specific line items comprises displaying the subset of the tenant-specific line items in rank order.

8. The method of claim 7, wherein ranking the subset of the tenant-specific line items is further based on previously selected tenant-specific line items from the subset of the tenant-specific line items.

9. The method of claim 1, further comprising:
receiving, at the user device, a user selection of a first tenant-specific line item from the subset of the tenant-specific line items; and
generating an invoice for the service job to be performed by the tenant for the customer based at least in part on the first tenant-specific line item.

10. The method of claim 1, wherein the machine learning model is a large language model (LLM).

11. The method of claim 1, wherein the generic line item comprises a generic service or a generic material, and wherein each of the plurality of tenant-specific line items comprises a tenant-specific service or a tenant-specific material.

12. A system comprising:
a user device associated with a tenant; and
at least one computing device configured to:
generate, using a machine learning model, a primary embedding, wherein the primary embedding is associated with a generic line item corresponding to a service job to be performed by the tenant;
generate, using the machine learning model, a plurality of secondary embeddings, wherein each of the plurality of secondary embeddings is associated with a particular tenant-specific line item from a plurality of tenant-specific line items;
based on comparing the primary embedding to each of the plurality of secondary embeddings, determine a subset of tenant-specific line items that corresponds to the generic line item from the plurality of tenant-specific line items; and
based on input data indicating that the service job is to be performed by the tenant for a customer, cause display, via the user device, of the subset of tenant-specific line items that corresponds to the generic line item.

13. The system of claim 12, wherein generating the primary embedding comprises converting text associated with the generic line item into a primary vector, and wherein generating the plurality of secondary embeddings comprises converting text associated with each of the plurality of tenant-specific line items into a secondary vector.

14. The system of claim 12, wherein the at least one computing device is further configured to:
cause storage of the plurality of secondary embeddings in an embedding database; and
update the stored plurality of secondary embeddings in response to determining that the plurality of tenant-specific line items has been modified.

15. The system of claim 12, wherein comparing the primary embedding to each of the plurality of secondary embeddings comprises determining a similarity between the primary embedding and each of the plurality of secondary embeddings, and
wherein determining the subset of the tenant-specific line items that corresponds to the generic line item comprises determining a subset of the plurality of secondary embeddings for which the similarity satisfies a threshold.

16. The system of claim 12, wherein the at least one computing device is further configured to:
receive, at the user device, a user selection of a first tenant-specific line item from the subset of the tenant-specific line items; and
generate an invoice for the service job to be performed by the tenant for the customer based at least in part on the first tenant-specific line item.

17. A non-transitory computer-readable medium storing instructions that, when executed, cause:
generating, using a machine learning model, a primary embedding, wherein the primary embedding is associated with a generic line item corresponding to a service job to be performed by a tenant;
generating, using the machine learning model, a plurality of secondary embeddings, wherein each of the plurality of secondary embeddings is associated with a particular tenant-specific line item from a plurality of tenant-specific line items;
based on comparing the primary embedding to each of the plurality of secondary embeddings, determining a subset of tenant-specific line items that corresponds to the generic line item from the plurality of tenant-specific line items; and
in response to receiving, at a user device associated with the tenant, input data indicating that the service job is to be performed by the tenant for a customer, causing display of the subset of tenant-specific line items that corresponds to the generic line item.

18. The non-transitory computer-readable medium of claim 17, wherein the instructions, when executed, further cause:
causing storage of the plurality of secondary embeddings in an embedding database; and
updating the stored plurality of secondary embeddings in response to determining that the plurality of tenant-specific line items has been modified.

19. The non-transitory computer-readable medium of claim 17, wherein comparing the primary embedding to each of the plurality of secondary embeddings comprises determining a similarity between the primary embedding and each of the plurality of secondary embeddings, and
wherein determining the subset of the tenant-specific line items that corresponds to the generic line item comprises determining a subset of the plurality of secondary embeddings for which the similarity satisfies a threshold.

20. The non-transitory computer-readable medium of claim 17, wherein the instructions, when executed, further cause:
receiving, at the user device, a user selection of a first tenant-specific line item from the subset of the tenant-specific line items; and
generating an invoice for the service job to be performed by the tenant for the customer based at least in part on the first tenant-specific line item.
